(19) United States
(12) Patent Application Publication
(10) Pub. No.: US 2026/0205945 A1
(43) Pub. Date: Jul. 16, 2026

(54) ALIGNING USER EQUIPMENT (UE) BEHAVIOR TO NETWORK ENERGY SAVING STATES

(71) Applicant: LENOVO (SINGAPORE) PTE. LTD., Singapore (SG)

(72) Inventors: Joachim LÖHR, Wiesbaden (DE); Prateek BASU MALLICK, Dreieich (DE); Ravi KUCHIBHOTLA, Chicago, IL (US)

(21) Appl. No.: 19/134,533

(22) PCT Filed: Feb. 8, 2024
(86) PCT No.: PCT/IB2024/051184

§ 371 Date: May 30, 2025

Related U.S. Application Data
(60) Provisional application No. 63/484,298, filed on Feb. 10, 2023.

(51) Int. Cl. H04W 52/02; H04W 72/23; H04W 76/28

(52) U.S. Cl. CPC H04W 52/0216; H04W 72/23; H04W 76/28

(57) ABSTRACT

Various aspects of the present disclosure relate to reducing energy consumption in wireless communication systems. For example, a UE can adapt its DRX behavior based on a broadcast network/cell DTX configuration. The UE can change or modify timers (e.g., drx timer states) based on a provided network/cell DTX configuration, and/or avoid starting uplink procedures that cannot complete when a network/cell is in DTX.

### TECHNICAL FIELD

This application claims priority to U.S. Provisional Patent Application No. 63/484,298, filed on Feb. 10, 2023, entitled ALIGNING USER EQUIPMENT (UE) BEHAVIOR TO NETWORK ENERGY SAVING STATES, which is hereby incorporated by reference its entirety.

### TECHNICAL FIELD

The present disclosure relates to wireless communications, and more specifically to aligning user equipment (UE) behavior to network energy saving states.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

While the adoption of 5G and technologies beyond 5G enables wireless communications systems to provide enhanced services at high data rates, these enhanced services often rely on denser networks, such as networks having an increasing number of cell sites and/or antennas, larger bandwidths, additional frequency bands, and so on. Further, as the number of devices and services increase, the potential environmental impact and operating costs due to device emissions and energy consumption can also increase, among other unintended drawbacks.

In some cases, a network can realize energy savings by implementing cell discontinuous transmission (DTX) and/or discontinuous reception (DRX). During cell DTX/DRX, the serving cell behavior, during non-active period or times, can include: a gNB turning off all transmission and reception for data traffic and reference signals (e.g., all downlink (DL)/uplink (UL) channels as well as DL/UL signals); the gNB turns off its transmission/reception only for data traffic (and still transit/receive reference signals); the gNB turns off its dynamic data transmission/reception (and still perform transmission/reception in periodic resources); and/or the gNB only transmits reference signals.

### SUMMARY

The present disclosure relates to methods, apparatuses, and systems that support reducing energy consumption in a wireless communications system by adapting UE DRX behaviors based on a broadcast network/cell DTX configuration. The UE can change or modify timers (e.g., drx timer states) based on a provided network/cell DTX configuration, and/or avoid starting uplink procedures that cannot complete when a network/cell is in DTX, among other techniques.

Some implementations of the method and apparatuses described herein may further include a UE wireless communication, comprising at least one memory and at least one processor coupled with the at least one memory and configured to cause the UE to receive, from a network entity, a first configuration based on a DTX configuration of the network entity, wherein the first configuration includes a first timer controlling an active duration at a beginning of a cell DTX cycle, receive, from the network entity, a second configuration associated with a DRX behavior of the UE, wherein the second configuration includes a set of timers and determine whether to monitor a Physical Downlink Control Channel (PDCCH) based at least in part of a status of the first timer and a status of the set of timers.

In some implementations of the method and apparatuses described herein, the DTX configuration identifies active transmission time periods of the network entity.

In some implementations of the method and apparatuses described herein, the first timer comprises a cell-specific onDuration Timer.

In some implementations of the method and apparatuses described herein, the processor is configured to cause the UE to determine whether to monitor PDCCH based at least in part on whether the first timer is running.

In some implementations of the method and apparatuses described herein, the processor is configured to cause the UE to determine whether to monitor PDCCH based at least in part on whether the UE is in ActiveTime according to the second configuration.

In some implementations of the method and apparatuses described herein, the processor is configured to cause the UE to determine whether to monitor PDCCH based at least in part on whether the UE is in DRX Active Time according to the second configuration.

Some implementations of the method and apparatuses described herein may further include a processor for wireless communication, comprising at least one controller coupled with at least one memory and configured to cause the processor to receive, from a network entity, a first configuration based on a DTX configuration of the network entity, wherein the first configuration includes a first timer controlling an active duration at a beginning of a cell DTX cycle, receive, from the network entity, a second configuration associated with a DRX behavior of the processor, wherein the second configuration includes a set of timers, and determine whether to monitor PDCCH based at least in part of a status of the first timer and a status of the set of timers.

In some implementations of the method and apparatuses described herein, the DTX configuration identifies active transmission time periods of the network entity.

In some implementations of the method and apparatuses described herein, the first timer comprises a cell-specific onDuration Timer.

In some implementations of the method and apparatuses described herein, the controller is configured to cause the processor to determine whether to monitor PDCCH based at least in part on whether the first timer is running.

In some implementations of the method and apparatuses described herein, the controller is further configured to cause the processor to determine whether to monitor PDCCH based at least in part on whether the processor is in ActiveTime according to the second configuration.

In some implementations of the method and apparatuses described herein, the controller is configured to cause the processor to determine whether to monitor PDCCH based at least in part on whether the processor is in ActiveTime according to the second configuration.

Some implementations of the method and apparatuses described herein may further include a method performed by a UE, comprising receiving, from a network entity, a first configuration based on a DTX configuration of the network entity, wherein the first configuration includes a first timer controlling an active duration at a beginning of a cell DTX cycle, receiving, from the network entity, a second configuration associated with a DRX behavior of the processor, wherein the second configuration includes a set of timers, and determining whether to monitor PDCCH based at least in part of a status of the first timer and a status of the set of timers.

Some implementations of the method and apparatuses described herein may further include a network entity for wireless communication, comprising at least one memory and at least one processor coupled with the at least one memory and configured to cause the network entity to generate a timer configuration based on a DTX configuration of the network entity and transmit the timer configuration to one or more UEs.

In some implementations of the method and apparatuses described herein, the DTX configuration identifies a pattern of non-active transmission time periods of the network entity.

In some implementations of the method and apparatuses described herein, the network entity transmits the timer configuration via L1/L2 signaling.

In some implementations of the method and apparatuses described herein, the network entity transmits the timer configuration via broadcast messaging to the one or more UEs.

Some implementations of the method and apparatuses described herein may further include a method performed by a network entity, the method comprising generating a timer configuration based on a DTX configuration of the network entity and transmitting the timer configuration to one or more UEs.

In some implementations of the method and apparatuses described herein, the DTX configuration identifies a pattern of non-active transmission time periods of the network entity.

In some implementations of the method and apparatuses described herein, the network entity transmits the timer configuration via L1/L2 signaling.

In some implementations of the method and apparatuses described herein, the network entity transmits the timer configuration via broadcast messaging to the one or more UEs.

### BRIEF DESCRIPTION OF THE DRAWINGS

FIG. 1 illustrates an example of a wireless communications system that supports aligning UE behavior to network energy saving states in accordance with aspects of the present disclosure.

FIG. 2 illustrates an example of a diagram that supports configuring a timer of a UE in accordance with aspects of the present disclosure.

FIG. 3 illustrates an example of a diagram that supports configuring another timer of a UE in accordance with aspects of the present disclosure.

FIG. 4 illustrates an example of a diagram that supports a UE following modified Active Time Procedures in accordance with aspects of the present disclosure.

FIG. 5 illustrates an example of a diagram that supports a UE following another modified Active Time Procedure in accordance with aspects of the present disclosure.

FIG. 6 illustrates an example of a diagram that supports a network/cell DTX configuration in accordance with aspects of the present disclosure.

FIG. 7 illustrates an example of a diagram that supports a network DTX configuration in accordance with aspects of the present disclosure.

FIG. 8 illustrates an example of a diagram that supports a UE following another modified Active Time Procedure in accordance with aspects of the present disclosure.

FIG. 9 illustrates an example of a block diagram of a device that supports aligning UE behavior to network energy saving states in accordance with aspects of the present disclosure.

FIG. 10 illustrates a flowchart of a method that supports modification of DRX behavior of a UE in accordance with aspects of the present disclosure.

FIG. 11 illustrates a flowchart of a method that supports sending a timer configuration to one or more UEs in accordance with aspects of the present disclosure.

### DETAILED DESCRIPTION

While the implementation of a network energy consumption model can significantly enable a network to realize energy savings, such a model can adversely impact operations and performance of various devices of the network, such as cells (e.g., base stations) and UEs.

For example, when a network employs DTX for one or more serving cells, the UEs associated with the serving cells may waste energy and resources when remaining in active reception modes (e.g., not in DRX), such as monitoring downlink (DL) channels (e.g., PDCCH channels), starting procedures (e.g., L2 procedures) that would lead to a network response, and so on.

Currently, a network may configure a (medium access control) MAC entity with a DRX functionality that controls UE Physical Downlink Control Channel (PDCCH) monitoring activity for various MAC entity identifiers. When using DRX operation, the MAC entity may also monitor PDCCH. For example, when in RRC_CONNECTED mode, when DRX is configured for all the activated Serving Cells, the MAC entity may monitor the PDCCH discontinuously using previously defined DRX operation (e.g., in TS 38.213).

Previous solutions can include changing the DRX configuration of each UE based on the network DTX configuration, the configuration indicating the ON/OFF DTX periods of the network. However, these solutions can lead to a significant amount of signaling (e.g., due to changing the DRX configuration of every connected UE in the cell).

To mitigate such drawbacks, the network can modify UE behavior (e.g., change or modify the DRX configuration of UEs) without utilizing signaling support. Instead, a UE adapts its DRX behavior based on a broadcast network/cell DTX configuration. For example, the UE can change or modify timers (e.g., drx timer states) based on a provided network/cell DTX configuration. Further, UE battery use can be enhanced or optimized, such as when a UE, using the techniques described herein, avoids starting L2 procedures (which cannot complete due to the absence of DL signaling during network/cell DTX).

Thus, the network can modify the UE behaviors without having to individually signal each of the UEs, saving network resources and preventing unnecessary performance of procedures by the UEs, among other benefits.

Aspects of the present disclosure are described in the context of a wireless communications system. Aspects of the present disclosure are further illustrated and described with reference to device diagrams and flowcharts.

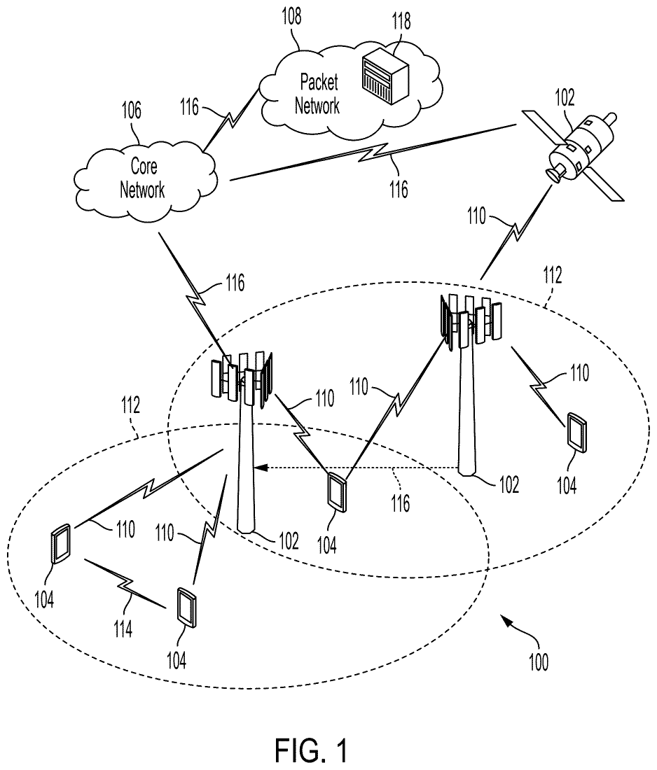

FIG. 1 illustrates an example of a wireless communications system 100 that supports aligning UE behavior to network energy saving states between UEs in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a network or cell (e.g., a serving cell) can activate a DTX/DRX configuration. For example, a cell DTX/DRX mode can be activated/de-activated via dynamic L1/L2 signaling and UE-specific RRC signaling. Both UE specific and common L1/L2 signaling can be utilized to activate/de-activate the cell DTX/DRX mode.

When access stratum (AS) receives the cell DTX/DRX information from the network, the AS informs Non-Access Stratum (NAS) of the DTX/DRX time of the network, and the NAS, based on the DTX/DRX time, supervises a NAS procedure (e.g., a registration (update), service requests, and so on). Thus, the network applies cell DTX/DRX in a time domain, such as with UEs in an RRC_CONNECTED state. For example, a gNB can configure a periodic cell DTX/DRX, and the gNB can configure a serving cell using UE-specific RRC signaling.

Further, a network can separately configure cell DTX and cell DRX modes (e.g., one RRC configuration set for DL (downlink) and another for UL (uplink)) or can be configured together. The following parameters, among other parameters, can be part of the cell DTX/DRX configuration: periodicity, start slot/offset, on duration, and so on.

As described herein, the network can modify UE behavior (e.g., change or modify the DRX configuration of UEs) without utilizing signaling support. The UE adapts its DRX behavior based on a broadcast network/cell DTX configuration. For example, the UE can change or modify timers (e.g., drx timer states) based on a provided network/cell DTX configuration.

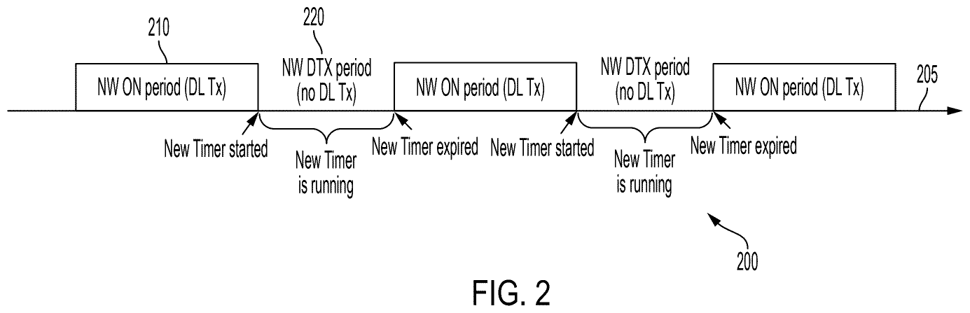

FIG. 2 illustrates an example of a diagram 200 that supports configuring a timer of a UE in accordance with aspects of the present disclosure. A timing pattern 205 includes a series of repeating network/cell periods, including network ON periods 210 followed by network DTX periods 220 (e.g., the network is not transmitting during the period). As described herein, network/cell DTX generally refers to non-transmission across all channels/signals and/or non-transmission for one or more specific channels/signals.

The UE includes a timer, which controls a time duration where the UE should not expect any PDCCH/PDSCH (Physical Downlink Shared Channel) data from a serving cell (e.g., the cell is in the network DTX period 220). As shown, the timer starts when the network/cell moves to DTX (e.g., begins a network DTX period 220).

In some cases, a new timer is configured and/or maintained for each serving cell and/or a new timer is configured/maintained for each cell group or MAC entity (e.g., the timer is applicable for all serving cells belonging to a cell group (e.g., MCG (master cell group) or SCG (secondary cell group)). In some cases, a new timer is configured/maintained for each UE.

When the timer is running, the UE is in DRX (non-ActiveTime) and does not monitor PDCCH, because the network/cell is in DTX and thus not performing DL transmissions (e.g., PDCCH/PDSCH and/or SSBs/CSI-RS (synchronization signal blocks)/channel state information reference signal)) to be received by the UE. Thus, the timer starts when the network/cell moves to (or is about to move to) DTX, causing the UE to move to DRX. As shown, when the timer expires, the UE ends DRX and begins receiving DL transmissions, which may occur as the network/cell has moved back to an active transmission mode.

In some cases, the network/gNB configures the new timer. The network/gNB can transmit a timer configuration, such as a configuration that indicates or defines time periods where the network/cell will stop transmitting data/control/reference symbols in the DL, and how those DTX time periods will repeat with a given configured periodicity (e.g., the periodicity of the time periods). The network/cell can utilize L1/L2 signaling to indicate to the UE the start times and stop times of the DTX periods of the network/cell.

In some cases, the network may broadcast the DTX pattern, and each UE that receives the broadcast can set a new timer value and configuration accordingly. For example, the UE may start the new timer when the moves to the DTX period (as shown in FIG. 2), where the timer runs for the duration of the DTX period of the network/cell. The timer stops or expires when the network/cell moves back to the ON period (e.g., begins performing transmissions of DL signals/channels), because the timer configuration is aligned to the network DTX configuration.

In some cases, UE may stop all drx-related timers when the new timer associated with the network/cell DTX starts running (e.g., aligned with the network/cell entering a DTX period). Drx-related timers can include: a drx-OndurationTimer, adrx-InactivityTimer, a drx-RetransmissionTimerDL, a drx-RetransmissionTimerUL, and/or a drx-RetransmissionTimerSL. Stopping drx-related timers can also stop the ActiveTime of the UE, causing the UE to stop monitoring PDCCH, as defined in TS38.321 and defined as follows:

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer (as described in clause 5.1.5) or msgB-ResponseWindow (as described in clause 5.1.4a) is running; or
a Scheduling Request is sent on PUCCH and is pending (as described in clause 5.4.4 or 5.22.1.5). If this Serving Cell is part of a non-terrestrial network, the Active Time is started after the Scheduling Request transmission that is performed when the SR COUNTER is 0 for all the SR configurations with pending SR(s) plus the UE-gNB RTT; or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a).

Further, in some cases, UE stops all drx-related timers and resets the timers once the new timer is started and/or can pause the drx-related timers when the new timer is running, such as during a DTX period of the network/cell.

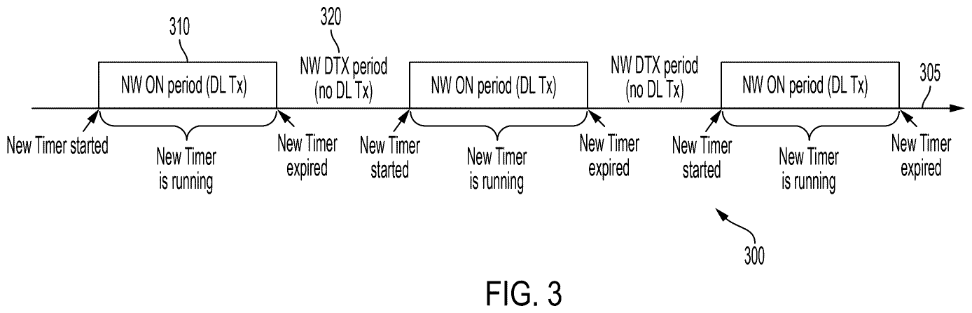

In some embodiments, the timer, or timer configuration, can be based on, or start from, the network/cell active transmission period. FIG. 3 illustrates an example of a diagram 300 that supports configuring another timer of a UE in accordance with aspects of the present disclosure.

Like the timing pattern 205 of FIG. 2, a timing pattern 305 includes a series of repeating network/cell periods, including network ON periods 310 followed by network DTX periods 320 (e.g., the network is not transmitting during the period). However, a new timer for the UE controls a duration where the UE expects network/cell to be in an “ActiveTime” mode, and thus sending DL signals to the UE, such as PDCCH/PDSCH or any kind of RS(s) in a serving cell. Thus, the timer, in such embodiments, starts when the network/cell enters the network ON period 310, and ends or expires when the network switches to the DTX period 320.

In some cases, the new timer can be configured and/or maintained per serving cell and indicates the duration where the UE expects the network/cell to be in a non-DTX state in the corresponding serving cell. As described herein, the timer can be configured/maintained for a given cell group or MAC entity (e.g., the timer is applicable for all serving cells belonging to a cell group (e.g., MCG or SCG)).

In some embodiments, the UE follows DRX procedures (e.g., defined in TS38.321) for time periods where the new timer is running. For example, the UE determines when the MAC entity is to be in Active Time for a given slot, considering grants/assignments/DRX Command MAC CE/Long DRX Command MAC CE received and Scheduling Requestd sent when evaluating all DRX Active Time conditions as specified in the DRX procedure (e.g., checking whether a drx-related timer is running in the slot).

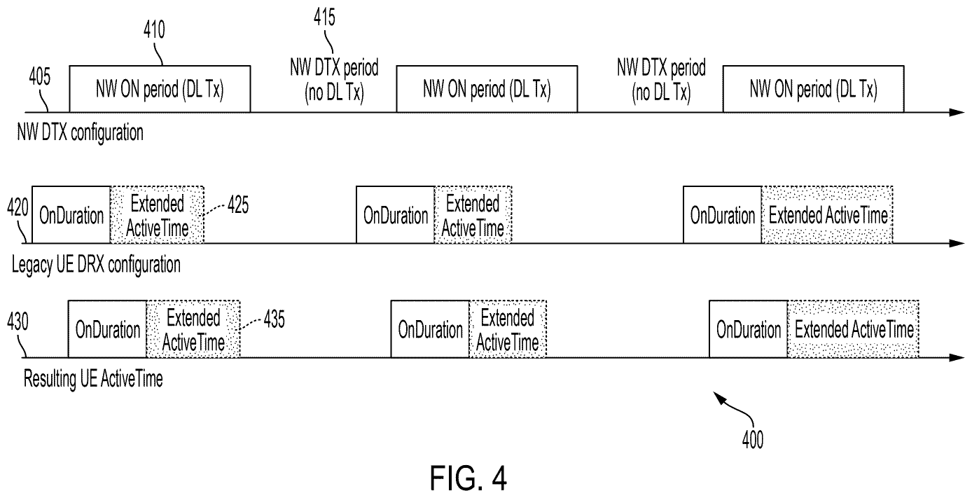

FIG. 4 illustrates an example of a diagram 400 that supports a UE following modified Active Time Procedures in accordance with aspects of the present disclosure. As described herein, a network timing pattern 405 includes a series of repeating network/cell periods, including network ON periods 410 followed by network DTX periods 415 (e.g., the network is not transmitting during the period).

A first UE, configured with legacy procedures, follows a DRX configuration 420 where a series of active receiving periods 425 (e.g., an OnDuration period followed by an Extended ActiveTime period) are not aligned to the DTX configuration of the network/cell DTX configuration. In contrast, a UE having been configured with one or more of the timers (e.g., new timers) described herein, implements and/or follows an ActiveTime configuration 430 having a series of active receiving periods 435 that are aligned to the network/cell network ON periods 410.

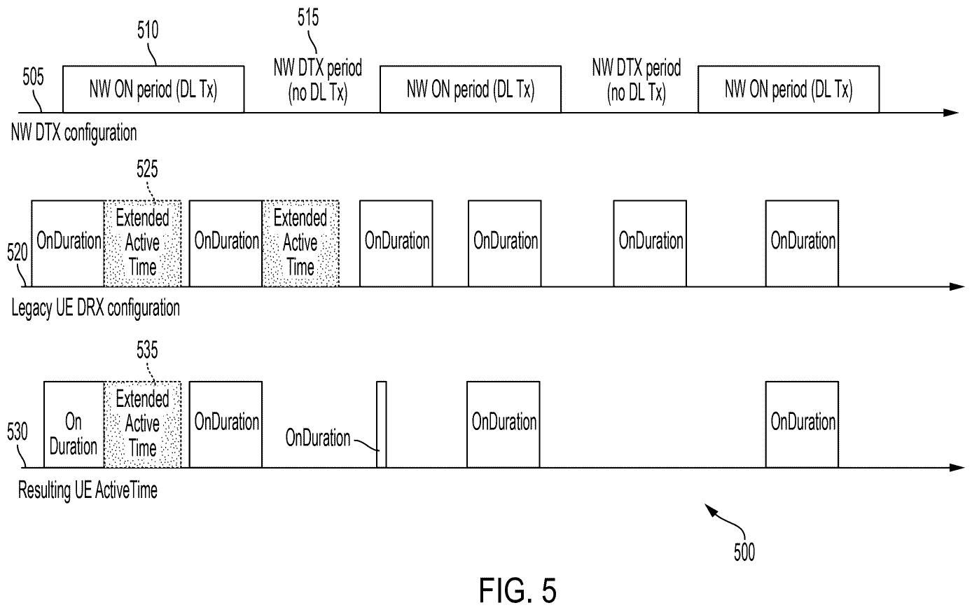

FIG. 5 illustrates an example of a diagram 500 that supports a UE following another modified Active Time Procedure in accordance with aspects of the present disclosure. As described herein, a network timing pattern 505 includes a series of repeating network/cell periods, including network ON periods 510 followed by network DTX periods 515 (e.g., the network is not transmitting during the period).

A first UE, configured with legacy procedures, follows a DRX configuration 520 where a series of active receiving periods 525 (e.g., an OnDuration period followed by an Extended ActiveTime period) are not aligned to the DTX configuration of the network/cell DTX configuration (e.g., the periods extend into the DTX of the network). In contrast, a UE having been configured with one or more of the timers (e.g., new timers) described herein, implements and/or follows an ActiveTime configuration 530 having a series of active receiving periods 535 that are aligned to the network/cell network ON periods 510. For example, the active receiving periods 535 may be shorter in duration, to avoid beginning before an active transmitting period of the network/cell commences.

In some cases, the UE/MAC may not be in ActiveTime in slots when a new timer is not running (e.g., the network/cell is in non-ActiveTime/DTX), such as when the timer controls time periods where the network/cell is actively transmitting.

In some cases, the UE stops all drx-related timers when the new timer controlling the network/cell non-DTX time periods expires or ends (e.g., when the network/cell moves into DTX). As described herein, the timers that may be stopped include the drx-Onduration Timer, the drx-InactivityTimer, the drx-RetransmissionTimerDL, the drx-RetransmissionTimerUL, and the drx-RetransmissionTimerSL. When stopped, the ActiveTime of the UE stops, and the UE stops monitoring PDCCH.

In some cases, the UE will stop all drx-related timers and reset them once the new timer expires, and/or pause the drx-related timers while the new timer controlling the network/cell DRX duration is not running.

Further, in some cases, the network/gNB configures the timer according to an NES configuration. The network can configure a pattern that defines time periods when the network will stop transmitting control/data and/or reference symbols (e.g., or any kind of DL transmissions) such as where the time periods (e.g., DTX periods) repeat with a given configured periodicity, as described herein.

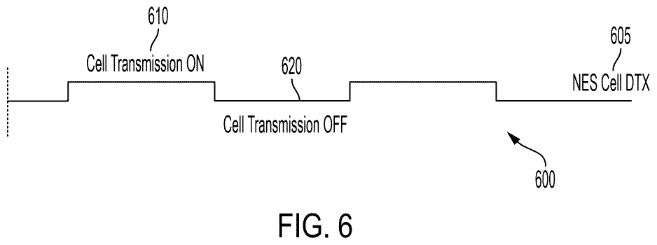

As described herein, the network determines a network/cell DTX configuration, such as before activating an NES mode. FIG. 6 illustrates an example of a diagram 600 that supports a network/cell DTX configuration in accordance with aspects of the present disclosure. A DTX configuration 605 can include repeating DTX periods, including a cell transmission ON period 610 (e.g., the cell is actively transmitting) and a cell transmission OFF period 620 (e.g., the cell is not-actively transmitting or is in DRX).

In some cases, the network/cell signals to each UE the cell DTX configuration 605, which is applicable for cases when energy saving is activated using either dedicated RRC signaling or broadcast signaling. In some cases, the DTX configuration can be a set of DRX parameters. Like a DRX configuration associated with legacy DRX operation, the DTX configuration 605 can include DTX cycles that include the cell transmission ON period 610 and the cell transmission OFF period 620.

For example, the cell transmission ON period 610 (e.g., “NW On Duration” or “NES_On Duration” defined in terms of milliseconds) can be a period in which the network circuitries would be or are running, and the network transmits over DL channels/signals.

Thus, the ON and OFF/DTX durations together form a network DTX duration (e.g., the DTX configuration 605) and repeat once every DTX Cycle period (e.g., configured by RRC).

In some cases, the network may control the start location of the DTX Cycle using a parameter that indicates an offset to a reference point, such as a subframe boundary. Once a DTX Cycle starts, the network transmission is active for a preconfigured duration, such as “NES-onDuration.” For example, the new timer (e.g., a drx-onDurationTimerNES) is set to the value “NES-onDuration” configured within the network/cell DTX configuration.

As described herein, when the new timer (e.g., drx-onDurationTimerNES) is running, the UE will apply the legacy DRX procedure and determines whether a slot is in ActiveTime based on the state of the drx-related timers and signals received from the network (e.g., grants/DRX control command) or sent on the uplink (e.g., SR). In some cases, the network/cell ON period (e.g., a time period when drx-onDurationTimerNES is running) is not extended dynamically (e.g., by transmission of a PDCCH/DCI (downlink control information)). Thus, even if the network sends a PDCCH/PDSCH at or near an end of the ON period (e.g., just before the network moves to a DTX period) the UE will not extend the ActiveTime (e.g., the network ON period is not extended).

In some embodiments, a UE or MAC entity maintains two ActiveTimes, one ActiveTime that is governed by the legacy DRX procedures (e.g., drx-related timer states) and one additional ActiveTime that is controlled by the network DTX configuration (e.g., by the new timer introduced for network energy savings as described herein). The additional ActiveTime (e.g., referred to as NW_ActiveTime) denotes the ON time duration of the UE when the network is transmitting over DL channels.

The UE ActiveTime (as determined by the legacy DRX procedure) can be a subset of or shorter than the NW_ActiveTime and the legacy UE ActiveTime. Thus, the UE can only be in ActiveTime during the NW_ActiveTime. For example, the NW_ActiveTime is a configured semi-static pattern, as described herein, and, in some cases, cannot be dynamically extended.

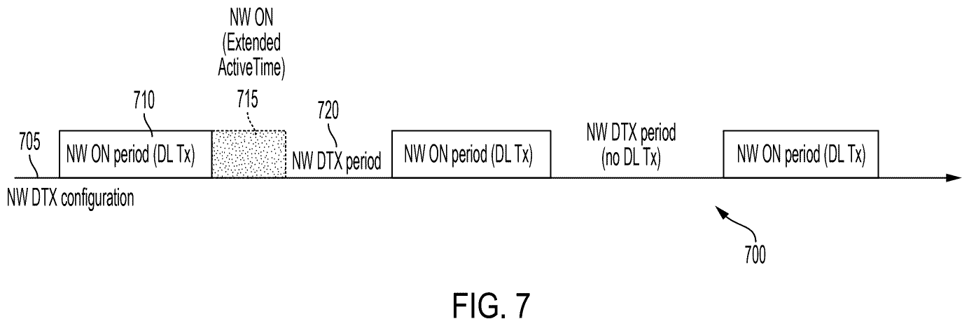

In some embodiments, the network dynamically extends the network ON time (e.g., the time period where the network transmits over DL channels, by means of a PDCCH/DCI). FIG. 7 illustrates an example of a diagram 700 that supports a network DTX configuration 705 in accordance with aspects of the present disclosure. The DTX configuration 705 includes a network ON period 710 followed by an extended ON period 715 and then a network DRX period 720.

For example, the UE starts a second timer in response to reception of a DCI (e.g., predefined DCI format) during the network ON time (e.g., NW_ActiveTime), such as when the first timer (e.g., drx-OndurationTimerNES is running. As another example, the second timer (e.g., drx-InactivityTimerNES) is configured according to the network DTX configuration.

In some embodiments, the DCI that triggers the start of the second timer and extends the network ON period (e.g., NW_ActiveTime) is a new DCI format that is monitored by all UEs in a cell. The DCI, which triggers the start of the drx-Inactivity TimerNES, is a DCI addressed to a new RNTI, which can be a group common RNTI, such as NES-RNTI. The new DCI format or DCI addressed to the new RNTI (e.g., NES-RNTI) may not allocate resources (e.g., for a PDSCH) but is used to extended the network ON period (e.g., NE_ActiveTime).

In some cases, not every PDCCH scheduling an initial transmission received during the NW-ActiveTime is extending the NW-ActiveTime. Only PDCCH/DCI addressed to a new RNTI (radio network temporary identifier) or a new DCI format or a DCI with fields set to certain predefined values may trigger the start of the drx-InactivityTimerNES.

In some embodiments, the UE can disable a DRX configuration configured for the UE and follow a network DTX pattern/configuration provided by broadcast or dedicated signaling. The UE may be monitoring PDCCH (e.g., ActiveTime) during the time periods where the network is in an ON state (e.g., performing transmission of DL channels/signals) and the UE is not monitoring PDCCH (e.g., DRX state) during the time periods where the network is in a DTX state (e.g., not performing transmission of DL channels/signals). For example, the UE autonomously disables or considers itself to be not configured with a DRX configuration when the network/cell provides the network DTX configuration.

In some embodiments, the UE starts the drx-OnDurationTimer at the beginning of a network ON period. The UE may not follow its configured DRX cycle, and instead follow the cycle provided by the network DTX configuration (e.g., a drx-OndurationTimer is started at every beginning of a network ON period). Thus, the drx timer values are maintained (e.g., only the start of the drx-Onduration Timer is shifted) and the beginning of the DRX cycle is aligned with the network ON periods.

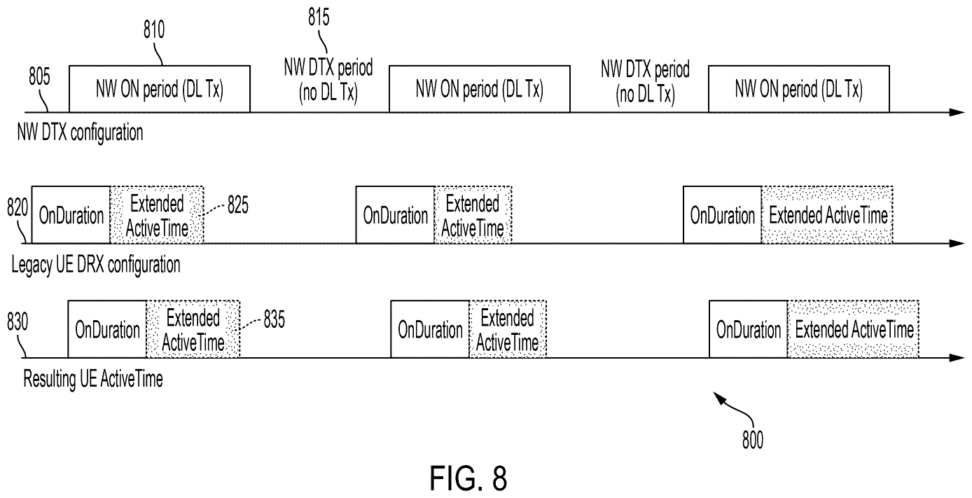

FIG. 8 illustrates an example of a diagram 800 that supports a UE following another modified Active Time Procedure in accordance with aspects of the present disclosure. As described herein, a network timing pattern 805 includes a series of repeating network/cell periods, including network ON periods 810 followed by network DTX periods 815 (e.g., the network is not transmitting during the period).

A first UE, configured with legacy procedures, follows a DRX configuration 820 where a series of active receiving periods 825 (e.g., an OnDuration period followed by an Extended ActiveTime period) are not aligned to the DTX configuration of the network/cell DTX configuration (e.g., the periods extend into the DTX of the network). In contrast, a UE having a DRX Cycle aligned to the network ON periods 810 implements and/or follows an ActiveTime configuration 830 having a series of active receiving periods 835 that are aligned to the network/cell network ON periods 810.

In some embodiments, the UE can switch to a dormant Bandwidth Part (BWP) configured for a serving cell during network OFF/DTX time periods. The UE can switch back to a previously active BWP, as configured, upon the network moving from the network OFF/DTX state to an ON state. For example, the UE stores the previously active BWP before entering the dormant BWP and autonomously switches to the BWP upon leaving the dormant BWP.

As another example, the UE can switch to the BWP (e.g., a DL BWP) indicated by firstOutsideActiveTimeBWP-Id or by firstWithinActiveTimeBWP-Id when leaving the dormant BWP. For example, a new trigger for entering and leaving a dormant BWP of a serving cell is defined based on the network moving from the ON state to the OFF/DTX state and/or from the OFF/DTX state to the ON state. In some cases, the UE switching to the dormant BWP when the network is in DTX implies that the UE/MAC does not monitor PDCCH or receive any DL data transmissions on PDSCH, as well as does not perform any uplink transmissions.

In some cases, disallowing UL transmissions is beneficial, such as for cases when a gNB is expected to turn off all transmission and reception for data traffic and/or reference signals during network DTX non-active periods (e.g., where the network is in DTX and also DRX states).

In some cases, there may be different levels of energy savings for a cell, such as only disabling DL transmissions on certain/all DL channels/signals or disabling the reception of UL transmission as well. It may be assumed that the network informs the UEs being served in a corresponding cell about the current energy saving configuration being (or to be) used in the cell.

Currently, a dormant BWP configuration is only supported for SCells (e.g., the dormant BWP configuration for SpCell or PUCCH SCell is not supported). However, dormant BWP can also be supported for PCell/SpCell or PUCCH SCell. Further, the UE may not clear any configured downlink assignments and any configured uplink grants that are Type 2 associated with the cell when switching to the dormant BWP.

In some embodiments, a UE can apply the same behavior on a current active BWP as if the BWP is a dormant BWP. The UE may not switch the BWP when entering/leaving the network DTX periods, and instead may consider the current active BWP as dormant.

In some embodiments, the UE may consider a cell as temporarily deactivated during time periods where a network is in a DTX state for a cell (e.g., SCell or PCell/sPCell). The UE may not clear any configured downlink assignments and any configured uplink grants Type 2 associated with the cell upon temporarily deactivating the cell (e.g., SPS and CG allocations/configurations may be maintained and only suspended).

The UE may also keep PUSCH resources configured for semi-persistent CSI reporting associated with the cell. Furthermore, the UE may also keep the content of the HARQ (hybrid automatic repeat request) buffer (e.g., not flushing the HARQ buffer) when temporarily deactivating a cell due to network DTX/DRX.

In some embodiments, the UE can be in a state, called a CellState, associated with the behavior of the UE when a network is in DTX/DRX state for a corresponding cell. This new state can be in addition to the already defined Cellstate, which is an activated state. In some cases, the field/parameter Cellstate can be applicable to PCell/PScell as well as SCells. The new CellState, which can be an NES state, defines the UE behavior when the network is in an OFF/DTX/DRX state for the corresponding cell.

For example, the UE sets the Cellstate autonomously to “NES_state” during the time periods when a network/gNB is in a DTX/DRX state (e.g., not transmitting any/certain DL channels/signals and/or not receiving any UL transmissions). The UE behavior in the new Cellstate “NES state” can include:
not transmitting on an uplink shared channel (UL-SCH) on the BWP; not transmitting on a radio access channel (RACH) on the BWP; not monitoring the PDCCH on the BWP; not transmitting PUCCH on the BWP; not reporting CSI for the BWP; not transmitting a sounding reference signal (SRS) on the BWP; not receiving a downlink shared channel (DL-SCH) on the BWP; suspending any configured downlink assignment and configured uplink grant of configured grant Type 2 on the BWP; suspending any configured uplink grant of configured grant Type 1 on the inactive BWP; and so on.

In some embodiments, the UE doesn't initiate a random access procedure (RACH) procedure triggered for cases when the Random Access Response window overlaps (at least partially) with the network DTX/OFF time duration. If a RACH procedure is triggered (e.g., requesting UL resources or triggered by PDCCH order or Beam Failure Recovery (BFR)), the UE checks whether the RAR window falls within the duration of the network DTX.

For cases that the RAR window (partially) overlaps with the network DTX duration, the UE does not initiate the RACH procedure (e.g., the UE does not perform a RACH preamble transmission). For example, the UE does not initiate a (triggered) RACH procedure for cases when the contention resolution window falls within the network DTX period.

In some cases, the UE determines for cases, such as when a RACH procedure is triggered, whether the RACH preamble transmission resources (for the initial RACH preamble transmission) occur at least a certain predetermined time offset before the start of a network DTX period. Thus, the UE may perform the RACH procedure only when the time offset is larger than a predefined threshold.

In some embodiments, the UE may not send a triggered SR on PUCCH (initial transmission of SR) for cases when the time duration/offset between the D-SR resources on PUCCH and the beginning of the next network DTX time period is smaller than a preconfigured threshold. For example, the threshold is configured by higher layer signaling.

The UE may not increase the SR transmission counter for cases when the SR transmission on PUCCH is not performed. In such cases, the UE sends a SR on PUCCH when a network DTX period immediately follows the SR transmission (e.g., the network cannot schedule UL resources for the transmission of a Buffer Status Report (BSR)). In such cases, the network may postpone the DTX state and send a DL information (e.g., DCI) to the UE. The UE, in parallel, may not immediately stop reception on the DL channels.

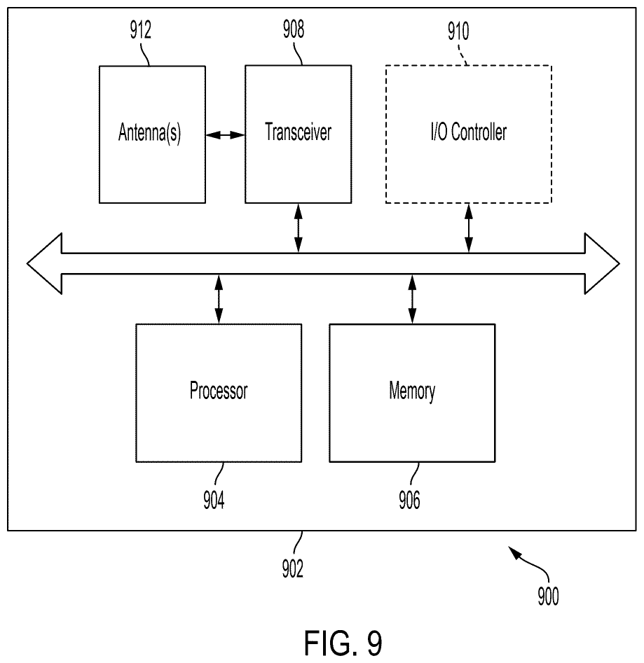

FIG. 9 illustrates an example of a block diagram 900 of a device 902 that supports aligning UE behavior to network energy saving states in accordance with aspects of the present disclosure. The device 902 may be an example of a network entity 102 or UE 104 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. The processor 904 may be configured as or otherwise support a means for receiving, from a network entity, a first configuration based on a DTX configuration of the network entity, wherein the first configuration includes a first timer controlling an active duration at a beginning of a cell DTX cycle, receiving, from the network entity, a second configuration associated with a DRX behavior of the UE, wherein the second configuration includes a set of timers, and determining whether to monitor PDCCH based at least in part of a status of the first timer and a status of the set of timers.

As another example, the processor 904 may support wireless communication at the device 902 in accordance with examples as disclosed herein. The processor 904 may be configured as or otherwise support a means for generating a timer configuration based on a DTX configuration of the network entity and transmitting the timer configuration to one or more UEs.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor M06. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

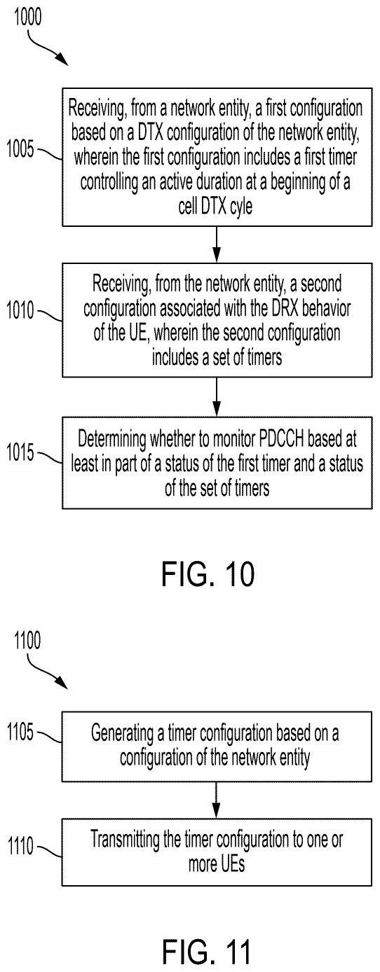

FIG. 10 illustrates a flowchart of a method 1000 that supports modification of DRX behavior of a UE in accordance with aspects of the present disclosure. The operations of the method 1000 may be implemented by a device or its components as described herein. For example, the operations of the method 1000 may be performed by the UE as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1005, the method may include receiving, from a network entity, a first configuration based on a DTX configuration of the network entity, wherein the first configuration includes a first timer controlling an active duration at a beginning of a cell DTX cycle. The operations of 1005 may be performed in accordance with examples as described herein. In some implementations, aspects of the operations of 1005 may be performed by a device as described with reference to FIG. 1.

At 1010, the method may include receiving, from the network entity, a second configuration associated with a DRX behavior of the UE, wherein the second configuration includes a set of timers. The operations of 1010 may be performed in accordance with examples as described herein. In some implementations, aspects of the operations of 1010 may be performed by a device as described with reference to FIG. 1.

At 1015, the method may include determining whether to monitor PDCCH based at least in part of a status of the first timer and a status of the set of timers. The operations of 1015 may be performed in accordance with examples as described herein. In some implementations, aspects of the operations of 1010 may be performed by a device as described with reference to FIG. 1.

FIG. 11 illustrates a flowchart of a method 1000 that supports sending a timer configuration to one or more UEs in accordance with aspects of the present disclosure. The operations of the method 1100 may be implemented by a device or its components as described herein. For example, the operations of the method 1100 may be performed by the network entity as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1105, the method may include generating a timer configuration based on a DTX configuration of the network entity. The operations of 1105 may be performed in accordance with examples as described herein. In some implementations, aspects of the operations of 1105 may be performed by a device as described with reference to FIG. 1.

At 1110, the method may include transmitting the timer configuration to one or more UEs. The operations of 1110 may be performed in accordance with examples as described herein. In some implementations, aspects of the operations of 1105 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”') indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A User Equipment (UE) for wireless communication, comprising:
at least one memory; and
at least one processor coupled with the at least one memory and configured to cause the UE to:
receive, from a network entity, a first configuration based on a discontinuous transmission (DTX) configuration of the network entity, wherein the first configuration includes a first timer controlling an active duration at a beginning of a cell DTX cycle;
receive, from the network entity, a second configuration associated with a discontinuous reception (DRX) behavior of the UE, wherein the second configuration includes a set of timers; and
determine whether to monitor a Physical Downlink Control Channel (PDCCH) based at least in part of a status of the first timer and a status of the set of timers.

2. The UE of claim 1, wherein the DTX configuration identifies active transmission time periods of the network entity.

3. The UE of claim 1, wherein the first timer comprises a cell-specific onDuration Timer.

4. The UE of claim 1, wherein the at least one processor is configured to cause the UE to determine whether to monitor PDCCH based at least in part on whether the first timer is running.

5. The UE of claim 1, wherein the at least one processor is configured to cause the UE to determine whether to monitor PDCCH based at least in part on whether the UE is in ActiveTime according to the second configuration.

6. The UE of claim 1, wherein the at least one processor is configured to cause the UE to determine, when the first timer is running, whether to monitor PDCCH based at least in part on whether the UE is in DRX ActiveTime according to the second configuration.

7. A processor for wireless communication, comprising:
at least one controller coupled with at least one memory and configured to cause the processor to:
receive, from a network entity, a first configuration based on a discontinuous transmission (DTX) configuration of the network entity, wherein the first configuration includes a first timer controlling an active duration at a beginning of a cell DTX cycle;
receive, from the network entity, a second configuration associated with a discontinuous reception (DRX) behavior of the processor, wherein the second configuration includes a set of timers; and
determine whether to monitor a Physical Downlink Control Channel (PDCCH) based at least in part of a status of the first timer and a status of the set of timers.

8. The processor of claim 7, wherein the DTX configuration identifies active transmission time periods of the network entity.

9. The processor of claim 7, wherein the first timer comprises a cell-specific onDuration Timer.

10. The processor of claim 7, wherein the at least one controller is configured to cause the processor to determine whether to monitor PDCCH based at least in part on whether the first timer is running.

11. The processor of claim 7, wherein the at least one controller is further configured to cause the processor to determine whether to monitor PDCCH based at least in part on whether the processor is in ActiveTime according to the second configuration.

12. The processor of claim 7, wherein the at least one controller is configured to cause the processor to determine, when the first timer is running, whether to monitor PDCCH based at least in part on whether the processor is in ActiveTime according to the second configuration.

13. A network entity for wireless communication, comprising:
at least one memory; and
at least one processor coupled with the at least one memory and configured to cause the network entity to:
generate a timer configuration based on a discontinuous transmission (DTX) configuration of the network entity; and
transmit the timer configuration to one or more user equipment (UEs).

14. The network entity of claim 13, wherein the DTX configuration identifies a pattern of non-active transmission time periods of the network entity.

15. The network entity of claim 13, wherein the network entity transmits the timer configuration radio resource control (RRC) signaling.

16. The network entity of claim 13, wherein the network entity transmits the timer configuration via broadcast messaging to the one or more UEs.

17. A method performed by a network entity, the method comprising:
generating a timer configuration based on a discontinuous transmission (DTX) configuration of the network entity; and
transmitting the timer configuration to one or more user equipment (UEs).

18. The method of claim 17, wherein the DTX configuration identifies a pattern of non-active transmission time periods of the network entity.

19. The method of claim 17, wherein the network entity transmits the timer configuration via radio resource control (RRC) signaling.

20. The method of claim 17, wherein the network entity transmits the timer configuration via broadcast messaging to the one or more UEs.
